(19) United States
(12) Patent Application Publication
(10) Pub. No.: US 2026/0158817 A1
(43) Pub. Date: Jun. 11, 2026

(54) DECORATIVE MATERIAL WITH 3D TEXTURE STRUCTURE, AND PREPARATION METHOD AND USE THEREOF

(71) Applicant: BANFERT NEW MATERIALS CO., LTD., Changsha (CN)

(72) Inventors: Xinxiong Li, Changsha (CN); Hui Li, Changsha (CN); Dongming Zhang, Changsha (CN)

(21) Appl. No.: 19/071,451

(22) Filed: Mar. 5, 2025

Related U.S. Application Data
(63) Continuation-in-part of application No. PCT/CN2024/143580, filed on Dec. 30, 2024.

(30) Foreign Application Priority Data
Dec. 11, 2024 (CN) 202411818314.2

(51) Int. Cl. B44C 3/02; B05D 3/12; B05D 5/00

(52) U.S. Cl. CPC B44C 3/02; B05D 3/12; B05D 5/00

(57) ABSTRACT

Provided are a decorative material with a 3D texture structure, and a preparation method and use thereof. Digital printing is conducted on a substrate after a pretreatment to obtain a 2D pattern layer on a surface of the substrate; a photocurable coating is applied onto a surface of the 2D pattern layer and a primary curing is conducted, and then a texture developer is ink-jet printed on a resulting primary cured surface and a secondary curing is conducted to obtain a cured coating including a hardened part and an unhardened part; and the unhardened part of the cured coating is removed by polishing and wire drawing, and a top coating is then applied to obtain the decorative material with the 3D texture structure.

### CROSS REFERENCE TO RELATED APPLICATION

This application is a continuation-in-part of International Application No. PCT/CN2024/143580, filed on Dec. 30, 2024, which claims priority of Chinese patent application No. 202411818314.2, filed with China Patent Office on Dec. 11, 2024, and entitled “DECORATIVE MATERIAL WITH 3D TEXTURE STRUCTURE, AND PREPARATION METHOD AND USE THEREOF”. The disclosure of the two applications is incorporated herein by reference in its entirety.

### TECHNICAL FIELD

The present disclosure relates to the technical field of decorative materials, and in particular to a decorative material with a 3D texture structure, and a preparation method and use thereof.

### BACKGROUND

At present, two-dimensional (2D) decoration effect can no longer satisfy the surface decoration of materials, and three-dimensional (3D) decoration is more favored. 3D decorative surface technology mostly uses the inherent characteristics of decorative materials to form 3D textures on flat materials by physical or mechanical means. For example, pressing textures into thermoplastic materials using molds at high temperatures or forming textures using laser engraving. These methods generally have high energy consumption, complex processes, high costs, or insufficient texture realism.

The updated technology uses advanced computer control techniques, digital printing techniques combined with new curing techniques in the process of pattern or coating formation, in order to achieve more realistic bionic 3D textures with simpler process path. However, the results are not ideal. For example, “additive ink”, which forms raised textures by ink-jet printing and piling up ink, is difficult to form an ideal stacking thickness due to the low viscosity and good fluidity of the ink, resulting in a significant difference from natural textures. Another example is “subtractive ink”, which forms recessed textures by removing part of the ink or coating with corrosive chemicals, and it requires the use of dangerous chemical materials and is prone to cause environmental pollution.

Another method uses “embossing liquid” to create textures, as described in CN110177691A, CN114015286B, and CN116533666A, where the “embossing liquid” is ink-jet printed on an uncured UV coating. The “embossing liquid” is uncurable liquid or a mixed liquid containing a polymerization inhibitor or a ultraviolet absorber, which prevents hardening after curing or results in a significantly lower hardness compared with an underlying coating. “Embossing liquid” parts are then removed to form textures, and recessed parts entirely correspond to the “embossing liquid”. This method requires a good match between surface energy, density, diffusion coefficient, and other parameters of the “embossing liquid” and the underlying coating, otherwise effective textures cannot be formed. Moreover, final 3D shape of the texture is the same as 3D shape of the “embossing liquid”, that is, edges of the texture are relatively rounded, which still shows a noticeable difference from 3D sense of natural textures.

### SUMMARY

In order to solve the problems existing in the prior art, the present disclosure provides a decorative material with a 3D texture structure, and a preparation method and use thereof. In the present disclosure, the preparation method could produce the decorative material with the 3D texture structure that is 3D realistic and has minimal differences from natural textures.

In order to achieve the above object, the present disclosure provides the following technical solutions:

The present disclosure provides a method for preparing a decorative material with a three-dimensional (3D) texture structure, including the following steps:

conducting digital printing on a substrate after a pretreatment to obtain a two-dimensional (2D) pattern layer on a surface of the substrate;

applying a photocurable coating onto a surface of the 2D pattern layer and conducting a primary curing, and ink-jet printing a texture developer on a resulting primary cured surface after the primary curing and conducting a secondary curing to obtain a cured coating, the cured coating including a hardened part and an unhardened part; and

removing the unhardened part of the cured coating by polishing and wire drawing, and then applying a top coating thereon to obtain the decorative material with the 3D texture structure.

In some embodiments, the pretreatment includes at at least one selected from the group consisting of leveling, filling, adhering, and covering.

In some embodiments, the digital printing includes one selected from the group consisting of ultraviolet (UV) ink printing, water-based ink printing, water-based UV ink printing, and solvent-based ink printing.

In some embodiments, the method further includes, after obtaining the 2D pattern layer and before applying the photocurable coating, applying at least one selected from the group consisting of a primer and a wear-resistant coating on the surface of the 2D pattern layer and curing.

In some embodiments, the photocurable coating includes a photocurable resin and a first photoinitiator;

the photocurable resin includes an acrylic resin; and

the acrylic resin includes at least one selected from the group consisting of a polyurethane acrylic resin, an epoxy acrylic resin, a polyester acrylic resin, a polyether acrylic resin, and a pure acrylic resin.

In some embodiments, the first photoinitiator has a maximum absorption peak at a wavelength of 350 nm to 420 nm; and

a mass of the first photoinitiator is 0.001% to 5% of a mass of the photocurable coating.

In some embodiments, the first photoinitiator includes at at least one selected from the group consisting of 2,4,6-trimethyl benzoyl diphenyl phosphine oxide, phenyl bis(2,4,6-trimethyl benzoyl) phosphine oxide, (2,4,6-trimethyl benzoyl) bis(p-tolyl) phosphine oxide), and ethyl (2,4,6-trimethyl benzoyl) phenylphosphinate.

In some embodiments, the photocurable coating further includes at least one selected from the group consisting of an active diluent, a coating auxiliary agent, and a second photoinitiator;

a mass of the second photoinitiator is 0.5% to 5% of a mass of the photocurable coating; and

the second photoinitiator has a maximum absorption peak at a wavelength of 200 nm to 350 nm.

In some embodiments, the second photoinitiator includes at least one selected from the group consisting of 1-hydroxycyclohexyl phenyl ketone, 2-hydroxy-2-methyl-1-phenyl-1-acetone, methyl benzoyl formate, oxy-bis(ethane-2,1-diyl) bis(2-oxo-2-phenylacetate), benzophenone, 4-chlorobenzophenone, and 4-methylbenzophenone.

In some embodiments, the primary curing is conducted by irradiating the photocurable coating using a primary curing light source, and a ultraviolet ray generated by the primary curing light source has a main wavelength of 350 nm to 420 nm; and

the photocurable coating obtained after the primary curing has a thickness of 10 μm to 300 μm.

In some embodiments, the texture developer includes a third photoinitiator;

the third photoinitiator has a maximum absorption peak at a wavelength of 200 nm to 420 nm; and

the third photoinitiator includes at least one selected from the group consisting of 2,4,6-trimethyl benzoyl diphenyl phosphine oxide, (2,4,6-trimethyl benzoyl) bis(p-tolyl) phosphine oxide, ethyl (2,4,6-trimethyl benzoyl) phenylphosphinate, phenyl bis(2,4,6-trimethyl benzoyl) phosphine oxide, 1-hydroxycyclohexyl phenyl ketone, 2-hydroxy-2-methyl-1-phenyl-1-acetone, methyl benzoyl formate, oxy-bis(ethane-2,1-diyl) bis(2-oxo-2-phenylacetate), benzophenone, 4-chlorobenzophenone, and 4-methylbenzophenone.

In some embodiments, a mass percentage of the third photoinitiator in the texture developer is not less than 20%.

In some embodiments, the texture developer further includes at least one selected from the group consisting of an acrylic resin, an active diluent, and a coating auxiliary agent.

In some embodiments, the active diluent includes 1,6-hexanediol diacrylate;

a mass percentage of the acrylic resin in the texture developer is not greater than 20%; and

a mass percentage of the active diluent in the texture developer is not greater than 70%.

In some embodiments, during the ink-jet printing the texture developer, a pattern and a position of the texture developer are consistent with a pattern and a position of the 2D pattern layer.

In some embodiments, the secondary curing is conducted by irradiating the photocurable coating coated with the texture developer using a secondary curing light source, and the secondary curing light source is at least one selected from the group consisting of a gallium lamp, a mercury lamp, a halogen lamp, and an electrodeless lamp.

In some embodiments, removing the unhardened part of the cured coating by polishing and wire drawing is conducted by using a polishing and wire drawing machine;

the polishing and wire drawing machine includes 4 groups to 10 groups of a high-hardness brush and 2 groups to 6 groups of a low-hardness brush; the high-hardness brush is a steel brush, the low-hardness brush is selected from the group consisting of a nylon brush and a composite brush, and the composite brush is made of a composite of a steel and a nylon; and

the polishing and wire drawing includes conducting a first polishing and wire drawing and a second polishing and wire drawing in sequence, the first polishing and wire drawing is conducted by using the high-hardness brush, and the second polishing and wire drawing is conducted by using the low-hardness brush.

In some embodiments, applying the top coating is conducted by applying the top coating 1 to 3 times.

The present disclosure further provides a decorative material with a 3D texture structure prepared by the method as described in above technical solutions.

The present disclosure further provides use of the decorative material with the 3D texture structure as described in above technical solutions in a floor or a decorative board.

The present disclosure provides a method for preparing a decorative material with a three-dimensional (3D) texture structure, including the following steps: conducting digital printing on a substrate after a pretreatment to obtain a two-dimensional (2D) pattern layer on a surface of the substrate; applying a photocurable coating onto a surface of the 2D pattern layer and conducting a primary curing, and ink-jet printing a texture developer on a resulting primary cured surface after the primary curing and conducting a secondary curing to obtain a cured coating, the cured coating including a hardened part and an unhardened part; and removing the unhardened part of the cured coating by polishing and wire drawing, and then applying a top coating thereon to obtain the decorative material with the 3D texture structure. In the present disclosure, the 3D texture forming process and 3D morphology are easier to control. The photocurable coating is semi-cured or has a high viscosity after the primary curing, and the texture developer does not need to enter the underlying coating like the “embossing liquid” in the prior art to form textures, and there is no need to control parameters such as density, diffusion coefficient, and surface tension. In the present disclosure, textures with different widths and depths could be obtained through the primary curing of a coating and the absorption of ultraviolet rays by a developer. In process of the polishing and wire drawing, a rough texture shape is drawn first, and then a burr is trimmed to obtain a more aesthetically pleasing texture. A depth of the wire drawing is controlled to increase gradually from shallow to deep, creating finer textures. Ultimately, a microscopically “rough” and visually smooth morphology is formed in the edges of the textures, which is closer to natural textures, and truly synchronized alignment could be achieved. The method shows simple process and strong controllability, and is easy to implement for batch industrial manufacture.

### BRIEF DESCRIPTION OF THE DRAWINGS

FIG. 1 shows a flowchart of the method for preparing a decorative material with a 3D texture structure in an embodiment of the present disclosure.

FIG. 2 shows a schematic diagram of a texture formation process in the decorative material in an embodiment of the present disclosure.

### DETAILED DESCRIPTION OF THE EMBODIMENTS

The present disclosure provides a method for preparing a decorative material with a three-dimensional (3D) texture structure, including the following steps:

conducting digital printing on a substrate after a pretreatment to obtain a two-dimensional (2D) pattern layer on a surface of the substrate;

applying a photocurable coating onto a surface of the 2D pattern layer and conducting a primary curing, and ink-jet printing a texture developer on a resulting primary cured surface after the primary curing and conducting a secondary curing to obtain a cured coating, the cured coating including a hardened part and an unhardened part; and

removing the unhardened part of the cured coating by polishing and wire drawing, and then applying a top coating thereon to obtain the decorative material with the 3D texture structure.

In present disclosure, digital printing is conducted on a substrate after a pretreatment to obtain a 2D pattern layer on a surface of the substrate. As an embodiment, the pretreatment includes at least one selected from the group consisting of leveling, filling, adhering, and covering.

In present disclosure, there are no special restrictions on the specific steps of the pretreatment, and those skilled in the art can choose appropriate pretreatment steps based on the differences in the substrate. As an embodiment, the substrate includes one selected from the group consisting of a plastic substrate, an inorganic board, a wooden substrate, a metal substrate, and a composite substrate, and preferably is one selected from the group consisting of a PVC substrate, a PET substrate, a calcium silicate board, and a glass magnesium board. In a specific embodiment of the present disclosure, the substrate is one selected from the group consisting of an SPC substrate, a particleboard, and a calcium silicate board.

In some embodiments of the present disclosure, under a condition that the substrate is the PVC substrate, the pretreatment includes: polishing and dedusting the substrate, applying a primer thereon and curing, and then applying a covering white base twice and then curing. In some embodiments of the present disclosure, the primer is BPVC-1335, with an applying amount of preferably 8 g/m²; and preferably the covering white base is BMZ-809W, preferably with an applying amount of 22 g/m² per applying.

In some embodiments of the present disclosure, under a condition that the substrate is the particleboard, the pretreatment includes: polishing and dedusting the substrate, applying infiltration strengthening primer Jetgood 4281 with an applying amount of 30 g/m²; applying filler putty BMZ-303A twice after curing, with an applying amount of 40 g/m² per applying, and curing after each applying; and then applying covering white base BMZ-809W twice, with an applying amount of 22 g/m² per applying, and curing after each applying.

In some embodiments of the present disclosure, under a condition that the substrate is the calcium silicate board, the pretreatment includes: polishing and dedusting the substrate, then applying infiltration strengthening primer BMZ-5100 with an applying amount of 35 g/m²; applying filler putty BMZ-303A twice after curing, with an applying amount of 40 g/m² per applying, and curing after each applying; and applying covering white base BMZ-809W twice, with an applying amount of 22 g/m² per applying, and curing after each applying.

As an embodiment, the digital printing includes UV ink printing, water-based ink printing, water-based UV ink printing, or solvent-based ink printing; and in a specific embodiment, the digital printing is conducted by UV ink printing.

In the present disclosure, after obtaining the 2D pattern layer, a photocurable coating is applied onto a surface of the 2D pattern layer and a primary curing is conducted, and then a texture developer is ink-jet printed on a resulting primary cured surface and a secondary curing is conducted to obtain a cured coating, the cured coating including a hardened part and an unhardened part.

As an embodiment, after obtaining the 2D pattern layer and before applying the photocurable coating, the method further includes applying at least one selected from the group consisting of a primer and a wear-resistant coating on the surface of the 2D pattern layer and curing. In some embodiments of the present disclosure, under a condition that the primer and the wear-resistant coating are applied on the surface of the 2D pattern layer, the primer is in contact with the 2D pattern layer. In the present disclosure, the components of the primer and the wear-resistant coating are not specifically limited, and those commonly known to those skilled in the art can be adopted. In practical applications, the decorative material obtained by adding the primer and/or the wear-resistant coating can be used as a floor.

In a specific embodiment of the present disclosure, the primer is BPVC-1335, preferably with an applying amount of 8 g/m²; and the wear-resistant coating is preferably formed from wear-resistant base BMZ-323C, with an applying amount of 60 g/m².

As an embodiment, the photocurable coating includes a photocurable resin and a first photoinitiator. As an embodiment, the photocurable resin includes an acrylic resin; and the acrylic resin preferably includes at at least one selected from the group consisting of a polyurethane acrylic resin, an epoxy acrylic resin, a polyester acrylic resin, a polyether acrylic resin, and a pure acrylic resin. In a specific embodiment of the present disclosure, a model of the epoxy acrylic resin is TUE75, and preferably a model of the polyurethane acrylic resin is selected from the group consisting of TUN208, TUN88, and TUN187. As an embodiment, the first photoinitiator has a maximum absorption peak at a wavelength of 350 nm to 420 nm. As an embodiment, the first photoinitiator includes at at least one selected from the group consisting of 2,4,6-trimethyl benzoyl diphenyl phosphine oxide, phenyl bis(2,4,6-trimethyl benzoyl) phosphine oxide, (2,4,6-trimethyl benzoyl) bis(p-tolyl) phosphine oxide), and ethyl (2,4,6-trimethyl benzoyl) phenyl phosphinate.

As an embodiment, a mass of the first photoinitiator is 0.001% to 5% of a mass of the photocurable coating.

As an embodiment, the photocurable coating further includes at least one selected from the group consisting of an active diluent, a coating auxiliary agent, and a second photoinitiator. In a specific embodiment of the present disclosure, the active diluent includes one selected from the group consisting of tripropylene glycol diacrylate and dipropylene glycol diacrylate.

As an embodiment, the second photoinitiator has a maximum absorption peak at a wavelength of 200 nm to 350 nm. As an embodiment, the second photoinitiator includes at least one selected from the group consisting of 1-hydroxycyclohexyl phenyl ketone (184), 2-hydroxy-2-methyl-1-phenyl-1-acetone (1173), methyl benzoyl formate (MBF), oxy-bis(ethane-2,1-diyl) bis(2-oxo-2-phenylacetate) (754), benzophenone (BP), 4-chlorobenzophenone (CBP), and 4-methylbenzophenone (MBP).

As an embodiment, a mass of the second photoinitiator is 0.5% to 5% of a mass of the photocurable coating. In some embodiments of the present disclosure, the first photoinitiator is a photoinitiator that absorbs a light with a longer wavelength, thereby ensuring good curing at the bottom of the coating; and the second photoinitiator is a photoinitiator that absorbs a light with a shorter wavelength, which is beneficial to surface curing, enabling the surface to achieve better hardness after the secondary curing.

As an embodiment, the primary curing is conducted by irradiating the photocurable coating using a primary curing light source, and a ultraviolet ray generated by the primary curing light source has a main wavelength of 350 nm to 420 nm, and the primary curing light source includes one selected from the group consisting of a UV-LED lamp and a gallium lamp, and the UV-LED lamp has a wavelength of 360 nm to 420 nm. In a specific embodiment, the primary curing light source is the UV-LED lamp. In the present disclosure, a purpose of the primary curing is to achieve cross-linking and hardening of the bottom of the photocurable coating, while making the surface layer have a low hardness or only be in a gel state.

As an embodiment, the photocurable coating obtained after the primary curing has a thickness of 10 μm to 300 μm; as another embodiment, the photocurable coating obtained after the primary curing has the thickness of 20 μm to 200 μm; and in a specific embodiment, the photocurable coating obtained after the primary curing has the thickness of 30μm to 150 μm. In the present disclosure, the thickness of the photocurable coating and the effect of the primary curing largely determine the depth of a final texture. In some embodiments of the present disclosure, the UV-LED lamp provides only long-wave ultraviolet rays, which, in combination with the first initiator, in the effect of surface oxygen polymerization inhibition, results in extremely low curing degree of the surface coating, but the bottom coating can cross-link and harden.

As an embodiment, the texture developer includes a third photoinitiator. As an embodiment, the third photoinitiator has a maximum absorption peak at a wavelength of 200 nm to 420 nm. As an embodiment, the third photoinitiator includes at least one selected from the group consisting of 2,4,6-trimethyl benzoyl diphenyl phosphine oxide, (2,4,6-trimethyl benzoyl) bis(p-tolyl) phosphine oxide, ethyl (2,4,6-trimethyl benzoyl) phenylphosphinate, phenyl bis(2,4,6-trimethyl benzoyl) phosphine oxide, 1-hydroxycyclohexyl phenyl ketone (184), 2-hydroxy-2-methyl-1-phenyl-1-acetone (1173), methyl benzoyl formate (MBF), oxy-bis(ethane-2,1-diyl) bis(2-oxo-2-phenylacetate) (754), benzophenone (BP), 4-chlorobenzophenone (CBP), and 4-methylbenzophenone (MBP).

In some embodiments of the present disclosure, the photoinitiator in the texture developer is in the best amount to ensure that ultraviolet rays irradiated onto the texture developer during the secondary curing are completely absorbed. As an embodiment, a mass percentage of the third photoinitiator in the texture developer is not less than 20%; and as another embodiment, the mass percentage of the third photoinitiator in the texture developer is not less than 50%.

As an embodiment, the texture developer further includes at least one selected from the group consisting of the acrylic resin, the active diluent, and the coating auxiliary agent. In some embodiments of the present disclosure, the active diluent includes 1,6-hexanediol diacrylate.

As an embodiment, a mass percentage of the acrylic resin in the texture developer is not greater than 20%. As an embodiment, a mass percentage of the active diluent in the texture developer is not greater than 70%, and in a specific embodiment, the mass percentage of the active diluent in the texture developer is not greater than 50%.

As an embodiment, during the ink-jet printing the texture developer, a pattern and a position of the texture developer are consistent with a pattern and a position of the 2D pattern layer, and a finally obtained 3D texture can achieve a synchronized alignment effect.

As an embodiment, the secondary curing is conducted by irradiating the photocurable coating coated with the texture developer using a secondary curing light source, and the secondary curing light source is at least one selected from the group consisting of a gallium lamp, a mercury lamp, a halogen lamp, and an electrodeless lamp.

In the present disclosure, after obtaining the cured coating, the unhardened part of the cured coating is removed by polishing and wire drawing, and then a top coating is applied thereon to obtain the decorative material with the 3D texture structure.

As an embodiment, removing the unhardened part of the cured coating by polishing and wire drawing is conducted by using a polishing and wire drawing machine.

As another embodiment, the polishing and wire drawing machine includes 4 groups to 10 groups of a high-hardness brush and 2 groups to 6 groups of a low-hardness brush; and the high-hardness brush is a steel brush, the low-hardness brush is selected from the group consisting of a nylon brush and a composite brush, and the composite brush is made of a composite of a steel and a nylon. In some embodiments of the present disclosure, the polishing and wire drawing includes conducting a first polishing and wire drawing and a second polishing and wire drawing in sequence, preferably the first polishing and wire drawing is conducted by using the high-hardness brush, and preferably the second polishing and wire drawing is conducted by using the low-hardness brush. In some embodiments of the present disclosure, during the polishing and wire drawing, a rough texture shape is first drawn by the steel brush with high hardness, and then a burr is trimmed by the nylon brush or the composite brush with low hardness to obtain a more aesthetically pleasing texture. As an embodiment, a drawing depth is controlled to gradually increase from shallow to deep, so as to draw a finer texture, finally forming a microscopically “rough” and visually smooth morphology in the edges of the textures, which is closer to natural textures.

As an embodiment, applying the top coating is conducted by applying the top coating 1 to 3 times.

In some embodiments of the present disclosure, under a condition that the decorative material is used in a floor, the top coating is a matte coating, and preferably a preparation for the matte coating includes: applying a first matte primer BPVC-1435 with an applying amount of 8 g/m², and applying a second matte topcoat BPVC-1035-05 with an applying amount of 10 g/m² after the first matte primer is cured, and then curing. After the matte coating is prepared, the preparation preferably further includes conducting a post-treatment, and preferably the post-treatment includes trimming, cutting, and grooving in sequence.

In some embodiments of the present disclosure, under a condition that the decorative material is used in furniture, the top coating is BMZ-1012-30 preferably with an applying amount of 12 g/m².

In some embodiments of the present disclosure, under a condition that the decorative material is used on wall surfaces, the top coating is BMZ-8240-10 applied twice, preferably with an applying amount of 6 g/m² per applying.

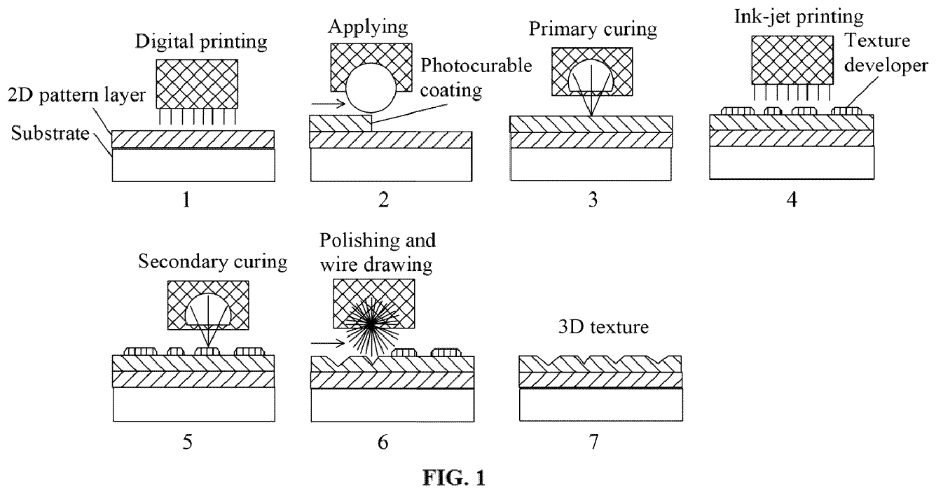

FIG. 1 shows a flowchart of the method for preparing a decorative material with a 3D texture structure in an embodiment of the present disclosure. As can be seen from FIG. 1, digital printing is conducted on a substrate after a pretreatment to obtain a 2D pattern layer on a surface of the substrate; a photocurable coating is applied onto a surface of the 2D pattern layer and a primary curing is conducted, and then a texture developer is ink-jet printed on a resulting primary cured surface and a secondary curing is conducted to obtain a cured coating; and an unhardened coating part in the cured coating is removed by polishing and wire drawing to obtain a 3D texture structure.

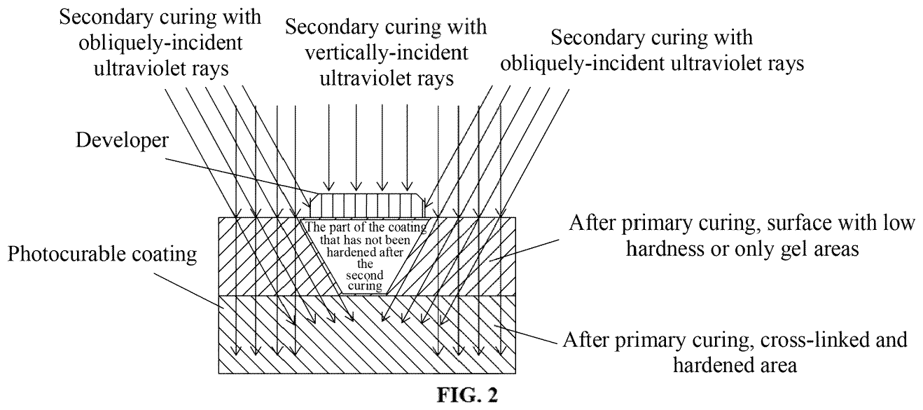

As shown in FIG. 2, the formation mechanism of the 3D texture in the method of an embodiment in the present disclosure is as follows: the primary curing of the photocurable coating results in a cross-linked and hardened bottom, but the surface thereof has a low hardness or only is in a gel state. After ink-jet printing the texture developer on the photocurable coating and conducting the secondary curing, the texture developer, containing a large amount of photoinitiators, absorbs all ultraviolet rays vertically incident on it, thereby preventing the ultraviolet rays from penetrating the developer and reaching the underlying photocurable coating. This ensures that the “unhardened coating part” below the developer could not be further cross-linked and hardened, still having a low hardness. Other parts of the photocurable coating not covered by the developer are fully cured and thereby have higher hardness under the effect of ultraviolet rays in the secondary curing, thus forming regions with obvious “hardness differences”. The texture developer, with its main ingredient being non-polymerizable photoinitiators, remains in a liquid or semi-solid state after ultraviolet ray exposure in the secondary curing. Under the subsequent action of the steel brush of a polishing and wire drawing machine, the texture developer and the “unhardened coating part” below it are mechanically removed, thereby forming textures. The existing ultraviolet ray sources contain a large amount of obliquely incident ultraviolet ray, and the obliquely incident ultraviolet ray is to make the “unhardened coating part” into a shape similar to the letter “V” as shown in the figure. The size of the area covered by the texture developer determines the width and depth of the textures, thus ultimately producing 3D textures of various shapes with different depths and widths.

The present disclosure further provides a decorative material with a 3D texture structure prepared by the method as described in above technical solutions.

The present disclosure further provides use of the decorative material with the 3D texture structure as described in above technical solutions in a floor or a decorative board.

As an embodiment, the decorative board includes a board of furniture or a board of a wall surface, and the furniture includes a cabinet.

The following detailed description is provided to illustrate the technical solutions of the present disclosure in conjunction with the examples, but the examples should not be construed as limiting the scope of the present disclosure.

### Example 1

A SPC substrate (a type of PVC substrate) was polished and dusted, and then adhesion primer BPVC-1335 was applied thereon, with an applying amount of 8 g/m². After curing, covering white base BMZ-809W was applied twice, with an applying amount of 22 g/m² per applying, and cured after each applying. Then digital printing was conducted with a UV ink to obtain a 2D pattern layer on a surface of the SPC substrate.

The adhesion primer BPVC-1335 was applied onto a surface of the 2D pattern layer with an applying amount of 8 g/m², and after curing, wear-resistant base BMZ-323C was applied with an applying amount of 60 g/m². A photocurable coating was applied after curing and a primary curing was conducted. The photocurable coating had a thickness of 150 μm and consisted of 67% of epoxy acrylic resin TUE75, 30% of tripropylene glycol diacrylate as the active diluent, 0.5% of 2,4,6-trimethyl benzoyl diphenyl phosphine oxide (with a maximum absorption peak at the wavelength of 380 nm) as the first photoinitiator, and 2.5% of MBF (with maximum absorption peaks at the wavelengths of 255 nm and 325 nm) as the second photoinitiator, all in mass percentages. A primary curing light source was a UV-LED lamp with a main emission wavelength of 395 nm.

Then, a texture developer was ink-jet printed on a resulting primary cured surface by using an ink-jet printer, ensuring that the texture developer was aligned with positions where a texture needed to be achieved, i.e., corresponding to positions of the 2D pattern layer. A secondary curing was conducted by using a mercury lamp to obtain a cured coating. The texture developer consisted of 50% of photoinitiator MBF, 20% of photoinitiator ethyl (2,4,6-trimethyl benzoyl) phenylphosphinate, and 30% of active diluent 1,6-hexanediol diacrylate, all in mass percentages.

Then an unhardened coating part in the cured coating was removed to form the texture by polishing and wire drawing, which was conducted by using a polishing and wire drawing machine. In the polishing and wire drawing machine, there were 10 groups of a steel brush and 2 groups of a composite brush, the composite brush was made of a composite of a steel and a nylon. During the polishing and wire drawing, a rough texture shape was first drawn by the steel brush with high hardness (i.e., a first polishing and wire drawing), and then a burr was trimmed by the composite brush with low hardness (i.e., a second polishing and wire drawing) to obtain a more aesthetically pleasing texture.

Finally, a decorative material with a 3D texture structure was obtained by applying a top coating twice. The top coating was a matte coating. In order to obtain a uniform matte effect, the top coating was obtained by applying matte primer BPVC-1435 once first with an applying amount of 8 g/m², and after curing, then applying matte topcoat BPVC-1035-05 once with an applying amount of 10 g/m² and curing. After trimming, cutting, and grooving, a floor with the 3D texture was obtained.

The adhesion primer BPVC-1335, the covering white base BMZ-809W, the wear-resistant base BMZ-323C, the epoxy acrylic resin TUE75, the matte primer BPVC-1435, and the matte top coating BPVC-1035-05 were all from Banfert New Materials Co., Ltd, China.

### Example 2

A particleboard (a type of wood substrate) was polished, leveled and dusted, and then infiltration strengthening primer Jetgood4281 was applied thereon, with an applying amount of 30 g/m²; after curing, filler putty BMZ-303A was applied twice, with an applying amount of 40 g/m² once, and cured after each applying; and then covering white base BMZ-809W was applied twice, with an applying amount of of 22 g/m² per applying, and cured after each applying. Then digital printing was conducted with a UV ink to obtain a 2D pattern layer on a surface of the particleboard.

A photocurable coating was applied onto a surface of the 2D pattern layer and a primary curing was conducted. The photocurable coating had a thickness of 50 μm and consisted of 42% of polyurethane acrylic resin TUN187, 20% of epoxy acrylic resin TUE75, 35% of active diluent tripropylene glycol diacrylate, 1% of first photoinitiator ethyl (2,4,6-trimethyl benzoyl) phenylphosphinate (with a maximum absorption peak at the wavelength of 366 nm), and 2% of second photoinitiator 184 (with a maximum absorption peak at the wavelength of 260 nm), all in mass percentages. A primary curing light source was a UV-LED lamp with a main emission wavelength of 395 nm.

Then, a texture developer was ink-jet printed on a resulting primary cured surface by using an ink-jet printer, ensuring that the texture developer was aligned with positions where a texture needed to be achieved, i.e., corresponding to positions of the 2D pattern layer. A secondary curing was conducted by using a mercury lamp to obtain a cured coating. The texture developer consisted of 50% of photoinitiator 1173, 20% of photoinitiator ethyl (2,4,6-trimethyl benzoyl) phenylphosphinate, 20% of photoinitiator CBP, and 10% of active diluent 1,6-hexanediol diacrylate, all in mass percentages.

Then, an unhardened coating part in the cured coating was removed to form the texture by polishing and wire drawing, which was conducted by using a polishing and wire drawing machine. In the polishing and wire drawing machine, there were 6 groups of a steel brush and 4 groups of a composite brush, the composite brush was made of a composite of a steel and a nylon. During the polishing and wire drawing, a rough texture shape was first drawn by the steel brush with high hardness (i.e., a first polishing and wire drawing), and then a burr was trimmed by the composite brush with low hardness (i.e., a second polishing and wire drawing) to obtain a more aesthetically pleasing texture.

Finally, a decorative board with a 3D texture structure was obtained by applying a top coating once and curing. The top coating was BMZ-1012-30, with an applying amount of 12 g/m². The decorative board could be used in furniture.

The infiltration strengthening primer Jetgood4281, the filler putty BMZ-303A, the covering white base BMZ-809W, the polyurethane acrylic resin TUN187, the epoxy acrylic resin TUE75, and top coating BMZ-1012-30 were all from Banfert New Materials Co., Ltd, China.

### Example 3

A calcium silicate board (a type of inorganic board) was polished, leveled and dusted, and then infiltration strengthening primer BMZ-5100 was applied thereon, with an applying amount of 35 g/m²; after curing, filler putty BMZ-303A was applied twice, with an applying amount of 40 g/m² per applying, and cured after each applying; and then covering white base BMZ-809W was applied twice, with an applying amount of 22 g/m² per applying, and cured after each applying. Then digital printing was conducted with a UV ink to obtain a 2D pattern layer on a surface of the calcium silicate board.

A photocurable coating was applied onto a surface of the 2D pattern layer and a primary curing was conducted. The photocurable coating had a thickness of 100 μm and consisted of 41.8% of polyurethane acrylic resin TUN208, 25% of polyurethane acrylic resin TUN88, 30% of active diluent dipropylene glycol diacrylate, and 0.2% of phenyl bis(2,4,6-trimethylbenzoyl) phosphine oxide (with maximum absorption peaks at wavelengths of 370 nm and 405 nm) as the first photoinitiator, and 3% of the second photoinitiator 754 (with maximum absorption peaks at wavelengths of 255 nm and 325 nm), all in mass percentages. A primary curing light source was a UV-LED lamp with a main emission wavelength of 405 nm.

Then, a texture developer was ink-jet printed on a resulting primary cured surface by using an ink-jet printer, ensuring that the texture developer was aligned with positions where a texture needed to be achieved, i.e., corresponding to positions of the 2D pattern layer. A secondary curing was conducted by using a mercury lamp to obtain a cured coating. The texture developer consisted of 10% of epoxy acrylic resin TUE21, 60% of photoinitiator 1173, and 30% of active diluent 1,6-hexanediol diacrylate, all in mass percentages.

Then an unhardened coating part in the cured coating was removed to form the texture by polishing and wire drawing, which was conducted by using a polishing and wire drawing machine. In the polishing and wire drawing machine, there were 10 groups of a steel brush and 4 groups of a nylon brush. In the polishing and wire drawing, a rough texture shape was first drawn by the steel brush with high hardness (i.e., a first polishing and wire drawing), and then a burr was trimmed by the nylon brush with low hardness (i.e., a second polishing and wire drawing) to obtain a more aesthetically pleasing texture.

Finally, a decorative board with a 3D texture structure was obtained by applying top coating BMZ-8240-10 twice, with an applying amount of 6 g/m² per applying, and cured after each applying. The decorative board could be used in a decoration of interior wall surfaces.

The infiltration strengthening primer BMZ-5100, the filler putty BMZ-303A, the covering white base BMZ-809W, polyurethane acrylic resins TUN208 and TUN88, the epoxy acrylic resin TUE21, and the top coating BMZ-8240-10 were all from Banfert New Materials Co., Ltd, China.

Although the above embodiments have provided a detailed description of the present disclosure, they are only a part, not all of the embodiments in the present disclosure. Other embodiments could be obtained based on these embodiments without involving inventiveness, which all fall within the scope of the present disclosure.

What is claimed is:

1. A method for preparing a decorative material with a three-dimensional (3D) texture structure, comprising:
conducting digital printing on a substrate after a pretreatment to obtain a two-dimensional (2D) pattern layer on a surface of the substrate;
applying a photocurable coating onto a surface of the 2D pattern layer and conducting a primary curing, and ink-jet printing a texture developer on a resulting primary cured surface after the primary curing and conducting a secondary curing to obtain a cured coating, the cured coating comprising a hardened part and an unhardened part; and
removing the unhardened part of the cured coating by polishing and wire drawing, and then applying a top coating thereon to obtain the decorative material with the 3D texture structure.

2. The method of claim 1, wherein the pretreatment comprises at least one selected from the group consisting of leveling, filling, adhering, and covering.

3. The method of claim 1, wherein the digital printing comprises one selected from the group consisting of ultraviolet (UV) ink printing, water-based ink printing, water-based UV ink printing, and solvent-based ink printing.

4. The method of claim 1, further comprising, after obtaining the 2D pattern layer and before applying the photocurable coating, applying at least one selected from the group consisting of a primer and a wear-resistant coating onto the surface of the 2D pattern layer and curing.

5. The method of claim 1, wherein the photocurable coating comprises a photocurable resin and a first photoinitiator;
the photocurable resin comprises an acrylic resin; and
the acrylic resin comprises at at least one selected from the group consisting of a polyurethane acrylic resin, an epoxy acrylic resin, a polyester acrylic resin, a polyether acrylic resin, and a pure acrylic resin.

6. The method of claim 5, wherein the first photoinitiator has a maximum absorption peak at a wavelength of 350 nm to 420 nm; and
a mass of the first photoinitiator is 0.001% to 5% of a mass of the photocurable coating.

7. The method of claim 6, wherein the first photoinitiator comprises at at least one selected from the group consisting of 2,4,6-trimethyl benzoyl diphenyl phosphine oxide, phenyl bis(2,4,6-trimethyl benzoyl) phosphine oxide, (2,4,6-trimethyl benzoyl) bis(p-tolyl) phosphine oxide, and ethyl (2,4,6-trimethyl benzoyl) phenylphosphinate.

8. The method of claim 5, wherein the photocurable coating further comprises at least one selected from the group consisting of an active diluent, a coating auxiliary agent, and a second photoinitiator;
a mass of the second photoinitiator is 0.5% to 5% of a mass of the photocurable coating; and
the second photoinitiator has a maximum absorption peak at a wavelength of 200 nm to 350 nm.

9. The method of claim 8, wherein the second photoinitiator comprises at least one selected from the group consisting of 1-hydroxycyclohexyl phenyl ketone, 2-hydroxy-2-methyl-1-phenyl-1-acetone, methyl benzoyl formate, oxy-bis(ethane-2,1-diyl) bis(2-oxo-2-phenylacetate), benzophenone, 4-chlorobenzophenone, and 4-methylbenzophenone.

10. The method of claim 1, wherein the primary curing is conducted by irradiating the photocurable coating using a primary curing light source, and a ultraviolet ray generated by the primary curing light source has a main wavelength of 350 nm to 420 nm; and
the photocurable coating obtained after the primary curing has a thickness of 10 μm to 300 μm.

11. The method of claim 1, wherein the texture developer comprises a third photoinitiator;
the third photoinitiator has a maximum absorption peak at a wavelength of 200 nm to 420 nm; and
the third photoinitiator comprises at least one selected from the group consisting of 2,4,6-trimethyl benzoyl diphenyl phosphine oxide, (2,4,6-trimethyl benzoyl) bis(p-tolyl) phosphine oxide, ethyl (2,4,6-trimethyl benzoyl) phenylphosphinate, phenyl bis(2,4,6-trimethyl benzoyl) phosphine oxide, 1-hydroxycyclohexyl phenyl ketone, 2-hydroxy-2-methyl-1-phenyl-1-acetone, methyl benzoyl formate, oxy-bis(ethane-2,1-diyl) bis(2-oxo-2-phenylacetate), benzophenone, 4-chlorobenzophenone, and 4-methylbenzophenone.

12. The method of claim 11, wherein a mass percentage of the third photoinitiator in the texture developer is not less than 20%.

13. The method of claim 11, wherein the texture developer further comprises at least one selected from the group consisting of an acrylic resin, an active diluent, and a coating auxiliary agent.

14. The method of claim 13, wherein the active diluent comprises 1,6-hexanediol diacrylate;
a mass percentage of the acrylic resin in the texture developer is not greater than 20%; and
a mass percentage of the active diluent in the texture developer is not greater than 70%.

15. The method of claim 1, wherein during the ink-jet printing the texture developer, a pattern and a position of the texture developer are consistent with a pattern and a position of the 2D pattern layer.

16. The method of claim 1, wherein the secondary curing is conducted by irradiating the photocurable coating coated with the texture developer using a secondary curing light source, and the secondary curing light source is at least one selected from the group consisting of a gallium lamp, a mercury lamp, a halogen lamp, and an electrodeless lamp.

17. The method of claim 1, wherein removing the unhardened part of the cured coating by polishing and wire drawing is conducted by using a polishing and wire drawing machine;
the polishing and wire drawing machine comprises 4 groups to 10 groups of a high-hardness brush and 2 groups to 6 groups of a low-hardness brush; the high-hardness brush is a steel brush, the low-hardness brush is selected from the group consisting of a nylon brush and a composite brush, and the composite brush is made of a composite of a steel and a nylon; and
the polishing and wire drawing comprises conducting a first polishing and wire drawing and a second polishing and wire drawing in sequence, the first polishing and wire drawing is conducted by using the high-hardness brush, and the second polishing and wire drawing is conducted by using the low-hardness brush.

18. The method of claim 1, wherein applying the top coating is conducted by applying the top coating 1 to 3 times.

19. A decorative material with a 3D texture structure prepared by the method of claim 1.
